(19) United States
(12) Patent Application Publication
(10) Pub. No.: US 2003/0193834 A1
(43) Pub. Date: Oct. 16, 2003

(54) Method and device for emulsifying, particularly for emulsifying water in a fuel

(75) Inventor: Egon Stache, Wedel (DE)

Correspondence Address: Ursula B. Day, Suite 3220, 350 Fifth Avenue, New York, NY, 10118, US

(73) Assignee: S.I.T. Schiffs- & Industrie Technik GmbH, Hamburg (DE)

(21) Appl. No.: 10/121,942

(22) Filed: Apr. 12, 2002

(51) Int. Cl. B01F 7/00

(52) U.S. Cl. 366/279

(57) ABSTRACT

In an emulsification device, in particular for emulsifying water in a fuel, a rotor is received in a stator and rotatably supported by a dual support. The liquid to be emulsified is swirled by the rotor rotating in the stator, whereby the rotor and the stator forming a milling gap which has a width that is smaller than 30 mm.

### BACKGROUND OF THE INVENTION

The present invention relates to a device and a method for emulsifying, particularly for emulsifying water in a fuel.

Such devices and methods are known, e.g. from German Patent No. DE 41 42 891 A1, and are particularly used on ships for preparing fuel, typically diesel or a heavy oil, in order to improve combustion. Besides filtering, the most important form of fuel preparation is emulsifying, which, i.a., may result in a reduction of nitrogen oxide emission. For this purpose, water is emulsified in the fuel, so that water droplets trapped in the fuel may explode in the combustion chamber through a so-called microexplosion, thereby tearing open the surrounding fuel envelope to finely distribute it. In addition, oxygen and hydrogen fractions improve the quality of combustion.

Conventional devices and methods suffer, however, shortcomings because the emulsification process is not yet optimal. In particular the width of the gap between rotor and stator, called “milling gap” is not small enough to permit emulsification of gas oil grades.

It would therefore be desirable and advantageous to provide an improved emulsifying device and method to obviate prior art shortcomings and to allow emulsification of water in fuels such as pure diesel.

### SUMMARY OF THE INVENTION

According to one aspect of the present invention, a device for emulsification, in particular for emulsifying water in a fuel, includes a stator; a rotor received in the stator; and a bearing assembly for rotatably supporting the rotor at two locations. Suitably, the rotor is spaced from the stator at formation of a milling gap having a width which is smaller than 30 mm.

According to another feature of the present invention, the rotor may be mounted on a shaft, and includes self-lubricating ball bearings for supporting the shaft at the two locations.

According to another feature of the present invention, there is provided at least one sliding ring seal having a spring assembly for adjusting a pressure in a rotating part of the sliding ring seal, wherein the sliding ring seal is constructed in such a way that the spring assembly in the rotating part of the sliding ring seal is not exposed to a liquid flow which has been emulsified and/or is being emulsified.

According to another feature of the present invention, there is provided at least one bearing housing, so constructed as to be protected from heat emitted by the liquid which has been emulsified and/or is being emulsified.

According to another feature of the present invention, the rotor may have a surface profile with sharp edges. Suitably, the surface of the rotor is formed with projections which have a polygonal shape, for example, triangular or rhomboidal configuration, in horizontal projection.

According to another aspect of the present invention, a method for emulsification, in particular for emulsifying water in a fuel, includes the step of swirling the liquid to be emulsified by a rotor rotating in a stator, with the rotor and the stator being spaced from one another at formation of a milling gap which has a width that is smaller than 30 mm. Suitably, the liquid to be emulsified is swirled by a rotor which has a sharp-edged surface profile.

According to yet another aspect of the present invention, a rotor for use in a device for emulsification, in particular for emulsifying water in a fuel, includes a surface formed with projections which are polygonal, for example, triangular or rhomboidal configuration, in horizontal projection.

The dual support of the rotor enables the provision an extremely small milling gap width between the rotor and the stator, whereby width can be 30 mm and less. This also reduces the size of the emulsified droplets, a fact that is beneficial because smaller droplets lead to an improved combustion.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a sectional view of a first embodiment of an emulsification device according to the present invention;

FIG. 2 is a detailed sectional view, on an enlarged scale, of the emulsification device of FIG. 1,

FIG. 3 is a schematic partial view of a rotor for the emulsification device having a first surface profile,

FIG. 4 is a schematic partial view of a rotor provided for the emulsification device having a second surface profile, and

FIG. 5 is a sectional view of a second embodiment of an emulsification device according to the present invention, having a rotor with sharp-edged surface.

### DETAILED DESCRIPTION OF PREFERRED EMBODIMENTS

Throughout all the Figures, same or corresponding elements are generally indicated by same reference numerals.

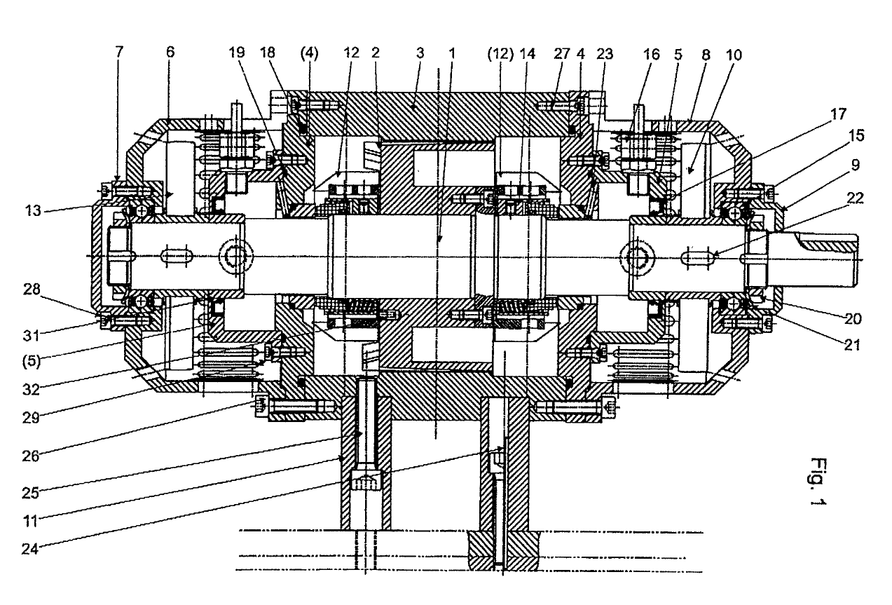

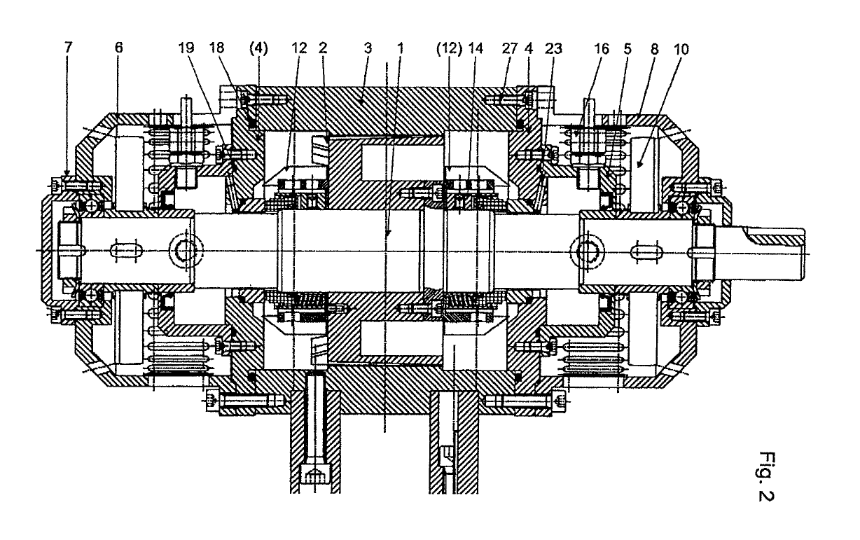

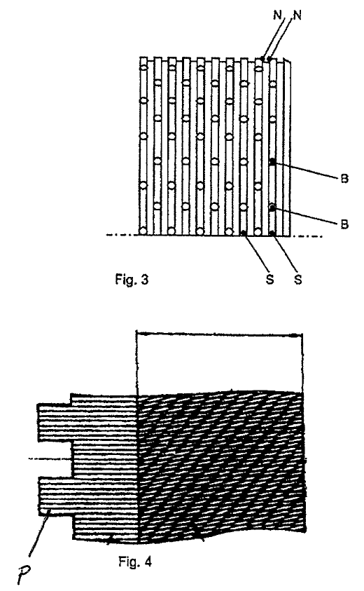

Turning now to the drawing, and in particular to FIGS. 1 and 2, there is shown a sectional view of a first embodiment of an emulsification device according to the present invention. The emulsification device can be provided in particular for the emulsification of water in a fuel, such as heavy oil or diesel and is useful, for example, on ships for preparing fuel. The emulsification device includes a shaft 1 and a rotor 2 which is mounted on the shaft 1 and received in a stator 3. The shaft 1 is rotatably supported outside the stator 3 by means of self-lubricating ball bearings 15. The particular surface profile of rotor 2, which plays an important role during emulsification, is not shown in FIG. 1 but illustrated in more detail in FIGS. 3 and 4 by way of example.

Two sliding ring seals 4 and two housings 5 are provided on opposite sides of the rotor 2, as viewed in axial direction along the shaft 1. A first fan wheel 13 is positioned in a first bearing housing 6 having a first end cap 7, and a second fan wheel 10 having a second end cap 9 is positioned in a second bearing housing 8. A leg 11 is provided for attachment of the emulsification device.

Since the liquids emulsified and/or to be emulsified emit significant heat when the emulsification device is used as intended, the bearing housings 6, 8 are suitably configured with ribs to ensure that only a very small amount of heat is able to reach the bearings 15. Together with correspondingly implemented seals and sealing elements, such as high temperature O-rings, it thus becomes possible to operate even in temperature ranges from 250 to 270° C. (in regard to the sliding ring seal).

Cares 12 are provided in chambers formed between the stator 3, the sliding ring seal seats 4, the sliding ring seals 14, and the rotor 2, for conjoint rotation with the rotor 2 and swirling of the emulsion and/or the liquids to be emulsified, in order to prevent the formation of oil cakes in these chambers, which would otherwise be problematic.

Sliding ring seals 14 are constructed in such a way that the spring assembly provided for adjusting the pressure in the rotating part of sliding ring seals 14 is not disposed in the oil stream, so as to achieve an extended useful life.

It should be noted that the device has additional components, such as straight screw-in threaded joint 16, radial shaft seal 17, various O-rings 18 and 19, groove nut 20, locking plate 21, feather key 22, pin 23, dowel pin 24, pan head screws 25, 26, 27, 28, 29, and 30, inner raceway 31, and cylindrical pin 32, and overall is suitably configured in such a way that all relevant components can be easily disassembled during maintenance work, without, for example, any need to break pipes or to cause leaks. As these components are generally known to a person skilled in the art that, a detailed description thereof has been omitted for the sake of simplicity.

FIGS. 3 and 4 show partial views of exemplified surface profiles of the rotor 2 for use in the emulsification device according to the present invention, the rotors having. The surface profile shown in FIG. 3 is formed by grooves N running parallel to one another and ribs S, as well as bores B formed in the ribs S. Only a few of the bores B are labeled here for reasons of clarity. The diameter of the bores B is slightly greater than the width of the ribs S.

The surface profile in FIG. 4, which is only schematically indicated, has multiple sharp-edged projections P, which are rhomboidal in horizontal projection, and which may be formed in practice, for example, by milling appropriate grooves into the originally smooth surface of a cylindrical rotor. Such a sharp-edged profile advantageously increases the shearing force effect on the liquids to be emulsified and particularly also allows the emulsification of diesel and water.

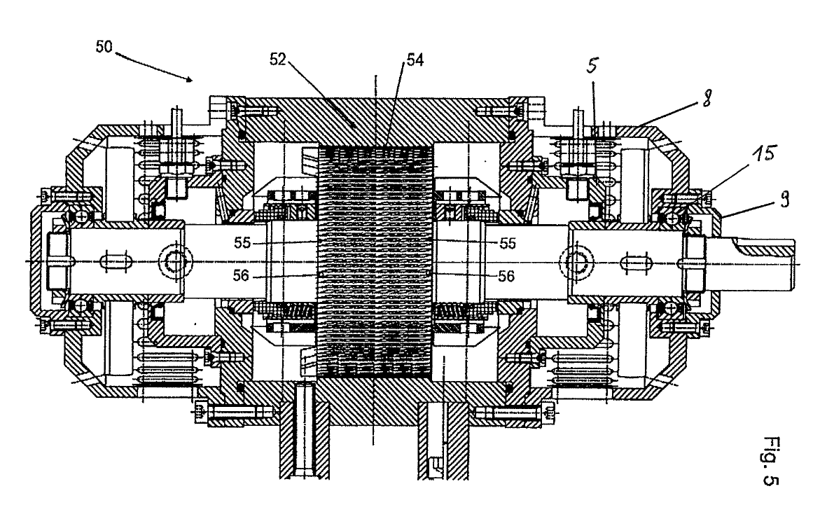

FIG. 5 shows a second embodiment of an emulsification device, generally designated by reference numeral 50 and including, in analogy to the emulsification device shown in FIG. 1, a rotor 54 rotatably supported in a stator 52. Other parts corresponding with those in FIG. 1 are denoted by identical reference numerals and not explained again. In this embodiment, the surface of the rotor 54 includes a plurality of projections 56 which are rhomboidal in horizontal projection, only a few of which are provided with reference numbers for reasons of clarity. These projections 56 “slice” in effect the liquids to be emulsified and expose the liquids to a particularly high shearing force, so that the rotor 54 is also suitable for emulsifying fluids such as diesel and water.

Numerous alterations and refinements are possible within the framework of the inventive concept, which, for example, relate to the construction of the bearing housing and the sliding ring seals. An important aspect of the present invention, however, is the support of the rotor on both sides, which allows the gap between the rotor and stator to be small. A further important aspect is the shape of the surface profile of the rotor, the shape having sharp edges particularly having proved itself.

While the invention has been illustrated and described as embodied in a method and device for emulsifying, particularly for emulsifying water in a fuel, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. An emulsification device, in particular for emulsifying water in a fuel, comprising a stator; a rotor received in the stator; and bearing means for rotatably supporting the rotor at two locations.

2. The device of claim 1, wherein the rotor is spaced from the stator at formation of a milling gap having a width which is smaller than 30 mm.

3. The device of claim 1, wherein the bearing means includes self-lubricating ball bearings.

4. The device of claim 1, wherein the rotor is mounted on a shaft, and further comprising bearing means for supporting the shaft at the locations, wherein the bearing means includes self-lubricating ball bearings.

5. The device of claim 1, and further comprising at least one sliding ring seal having a spring assembly for adjusting a pressure in a rotating part of the sliding ring seal, wherein the sliding ring seal is constructed in such a way that the spring assembly in the rotating part of the sliding ring seal is not exposed to a flow of liquid which has been emulsified and/or is being emulsified.

6. The device of claim 1, and further comprising at least one bearing housing, so constructed as to be protected from heat emitted by a liquid which has been emulsified and/or is being emulsified.

7. The device of claim 1, wherein the rotor has a surface profile with sharp edges.

8. The device of claim 7, wherein the surface of the rotor is formed with projections which have a polygonal shape in horizontal projection.

9. The device of claim 7, wherein the projections have a triangular or rhomboidal configuration.

10. A method for emulsification, in particular for emulsifying water in a fuel, comprising the step of swirling a liquid to be emulsified by a rotor rotating in a stator, with the rotor and the stator being spaced from one another at formation of a milling gap which has a width that is smaller than 30 mm.

11. The method of claim 10, wherein the liquid to be emulsified is swirled by a rotor having a sharp-edged surface profile.

12. A rotor for application in an emulsification device, in particular for emulsifying water in a fuel, said rotor having a surface formed with projections which are polygonal, in horizontal projection.

13. The rotor of claim 12, wherein the projections have a triangular or rhomboidal configuration.
